(19) United States
(12) Patent Application Publication
(10) Pub. No.: US 2012/0313826 A1
(43) Pub. Date: Dec. 13, 2012

(54) HOUSING OF ELECTRONIC DEVICE AND METHOD

(75) Inventors: ZHAO-YI WU, Shenzhen City (CN); YONG YAN, Shenzhen City (CN); YONG-FA FAN, Shenzhen City (CN); XUE-LI ZHANG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/211,752

(22) Filed: Aug. 17, 2011

(30) Foreign Application Priority Data
Jun. 10, 2011 (CN) 201110155725.4

(51) Int. Cl. H01Q 1/24; B29C 45/14; B82Y 99/00

(52) U.S. Cl. 343/702; 264/272.11; 977/932

(57) ABSTRACT

A portable electronic device includes a base, an antenna radiator, an outer layer, and at least one conductive contact. The antenna radiator formed on the base, the antenna radiator is made by injection molding from a mixture of materials selected from a group consisting of thermoplastic, organic filling substances, and conductive small particle sized material. The antenna radiator is sandwiched between the base and the outer layer. One end of each conductive contact is electrically connected to the antenna radiator, and the other end of the each conductive contact is exposed.

### BACKGROUND

1. Technical Field

The present disclosure relates to housings of electronic devices, especially to a housing having an antenna formed thereon and a method for making the housing.

2. Description of Related Art

Electronic devices, such as mobile phones, personal digital assistants (PDAs) and laptop computers are widely used. Most of these electronic devices have antenna modules for receiving and sending wireless signals. A typical antenna includes a thin metal radiator element mounted to a support member, and attached to a housing. However, the radiator element is usually exposed from the housing, and may be easily damaged and has a limited receiving effect. In addition, the radiator element and the support member occupy precious space.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary process for surface treating aluminum or aluminum alloys and housings made of aluminum or aluminum alloys treated by the surface treatment. Moreover, in the drawings like reference numerals designate corresponding parts throughout the several views. Wherever possible, the same reference numbers are used throughout the drawings to refer to the same or like elements of an embodiment.

FIG. 1 is a schematic view of an exemplary embodiment of a housing of a first embodiment.

FIG. 2 is a cross-sectional view of a portion of the housing taken along line II-II of FIG. 1.

FIG. 3 is a cross-sectional view of a portion of a molding machine of making the housing of FIG. 1.

FIG. 4 is similar to FIG. 3, but showing a base formed.

FIG. 5 is similar to FIG. 3, but showing an antenna radiator formed on the base.

FIG. 6 is a schematic view of a PVD machine used in the present process.

### DETAILED DESCRIPTION

The disclosure is illustrated by way of example and not by way of limitation in the accompanying drawings. It should be noted that references to “an” or “one” embodiment in this disclosure are not necessarily to the same embodiment, and such references can include the meaning of “at least one” embodiment where the context permits.

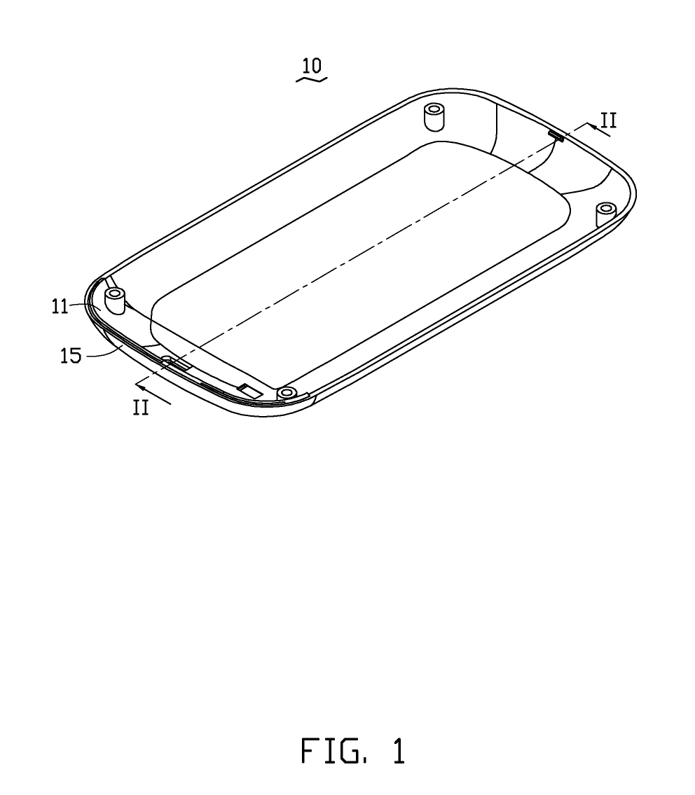

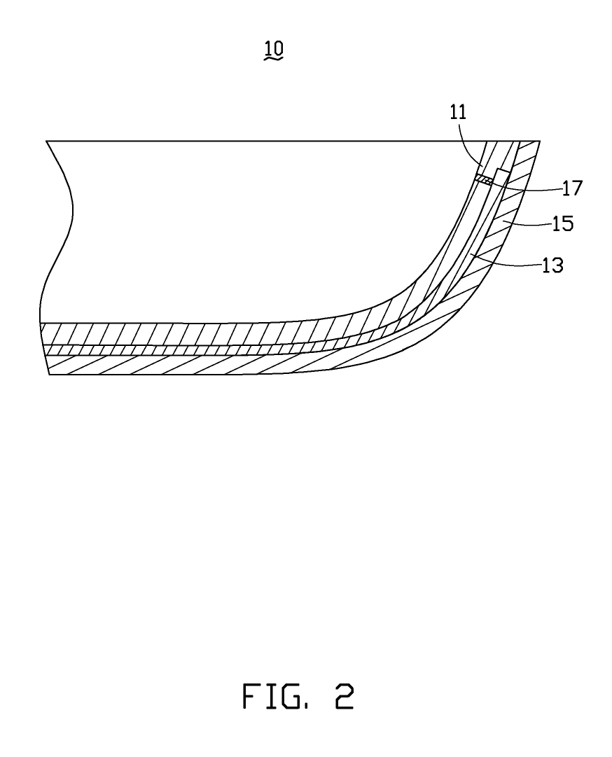

FIG. 1 shows a first embodiment of a housing 10 for an electronic device where an antenna is desired, such as a mobile phone, or a PDA. Referring to FIG. 2, the housing 10 includes a base 11, an antenna radiator 13, an outer layer 15, and a number of conductive contacts 17. The antenna radiator 13 is a three dimensional antenna and is formed on the base 11 and is buried by the outer layer 15. The conductive contacts 17 are embedded in the housing 10 by insert-molding. One end of each conductive contact 17 is electrically connected to the antenna radiator 13, and the other end is exposed so that the electronic device can receive signals from the antenna radiator 13 or transmit signals by the antenna radiator 13.

Referring to FIG. 2, the base 11 may be made of moldable plastic. The moldable plastic may be one or more thermoplastic materials selected from a group consisting of polypropylene (PP), polyamide (PA), polycarbonate (PC), polyethylene terephthalate (PET), and polymethyl methacrylate (PMMA).

The antenna radiator 13 is made of conductive plastic, which is a mixture of materials consisting of thermoplastic, organic filling substances, and conductive small particle sized material i.e., material having a diameter that would be typically described using the dimension “nanometers”. The resistivity of mixture is equal to or lower than 1.5˜10×10⁻⁸ Ω·m at 20° C. The mixture includes: the thermoplastic—65% to 75% by weight, the organic filling substances—22% to 28% by weight, and the non-conductive oxide—3% to 7% by weight. The thermoplastic can be made of polybutylene terephthalate (PBT) or polyesterimide (PI). The organic filling substances can be made of silicic acid and/or silicic acid derivatives.

The conductive small particle sized material may be nanoparticles of silver (Ag), gold (Au), copper (Cu), nickel (Ni), palladium (Pd), platinum (Pt), or an alloy thereof. The particle diameter of the metal nanoparticles may be equal to or less than 75 nanometers (nm), with smaller particle sizes easing formation for injection. The conductive small particle sized material may also be conductive nanometer calcium carbonate, fabricated of calcium carbonate (CaCO₃), tin (Sn), and antimony (Sb). The mass ratio of CaCO₃: Sn: Sb is approximately 55˜90: 9˜40: 1˜10, using nanometer sized calcium carbonate as nucleosome and forming tin dioxide doped with an antimony coating on the calcium carbonate surface by chemical co-deposition. The conductive small particle sized material may be carbon nanotubes. The particle diameter of the carbon nanotubes may be 20 nm˜40 nm, and the length of the carbon nanotubes may be 200 nm˜5000 nm. The conductive small particle sized material may be carbon nanofiber, graphite nanofiber, or metal nanofiber. The particle diameter of the nanofibers may be 20 nm˜40 nm.

The outer layer 15 may be made of Silicon Nitrogen (Si—N) layer. The Si—N layer is forming by physical vapor, deposition (PVD).

A method for making the housing 10 of the embodiment includes the following steps:

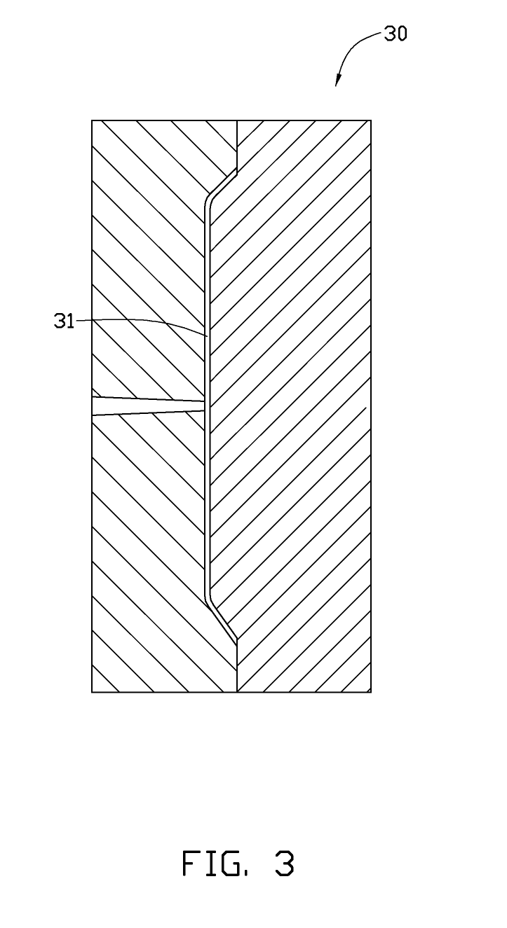

Referring to FIG. 3, an injection molding machine 30 is provided. The injection molding machine 30 is a multi-shot molding machine and includes a first molding chamber 31.

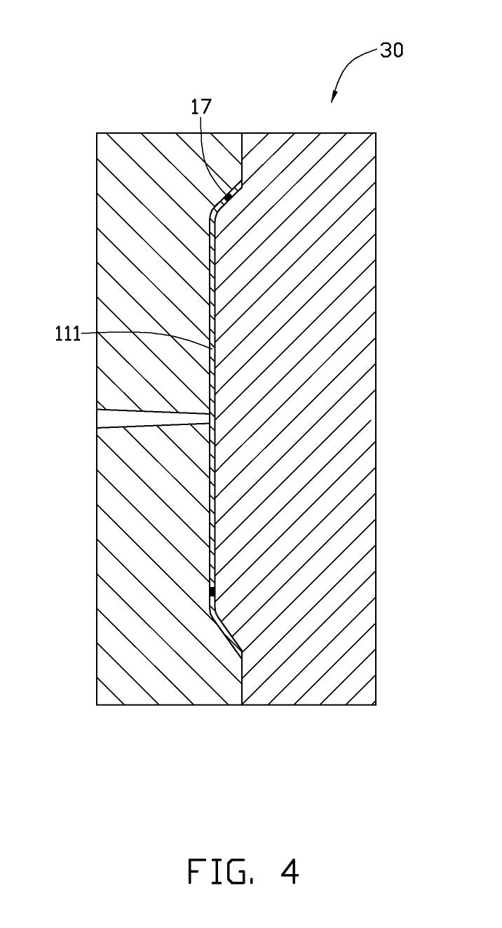

Referring to FIG. 4, the conductive contacts 17 are placed in the injection molding machine 30, and the thermoplastic material is injected into the first molding chamber 31 to form the base 11. The moldable plastic may be one or more thermoplastic materials selected from a group consisting of PP, PA, PC, PET, and PMMA.

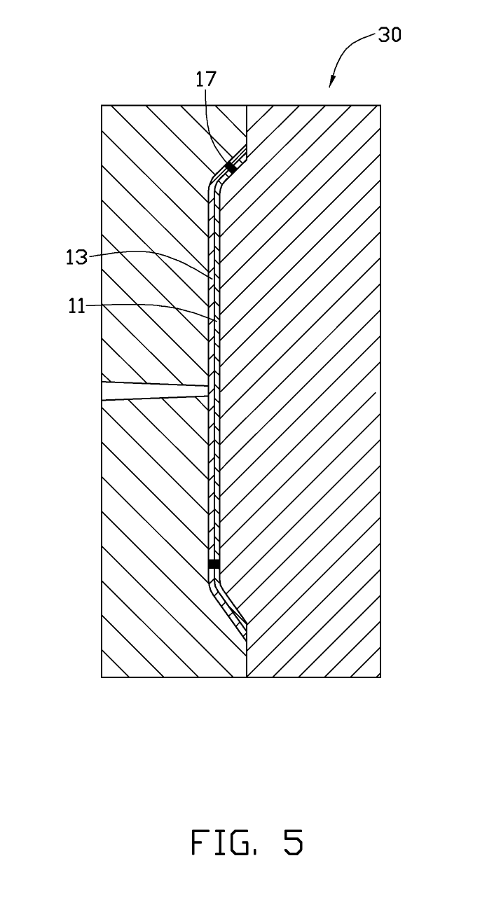

Referring to FIG. 5, the mixture of materials consisting of thermoplastic, organic filling substances, and conductive small particle sized material, is injected into the first molding chamber 31 to form the antenna radiator 13 covering at least one part of the base 11. The thermoplastic can be made of PBT or PI. The organic filling substances can be made of silicic acid and/or silicic acid derivatives. The conductive small particle sized material can be nanoparticles of metal, nanometer sized calcium carbonate, carbon nanotubes, or nanofibers, as described above.

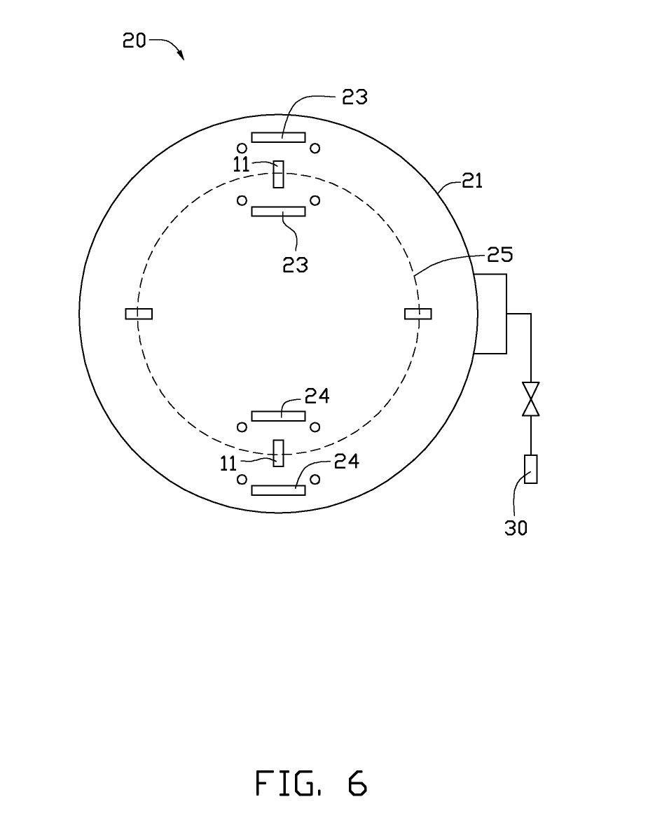

An vacuum sputtering process may be used to form the outer layer 15 by a vacuum sputtering device 20. Referring to FIG. 6, the vacuum sputtering device 20 includes a vacuum chamber 21 and a vacuum pump 30 connected to the vacuum chamber 21. The vacuum pump 30 is used for evacuating the vacuum chamber 21. The vacuum chamber 21 has a pair of chromium targets 23, a pair of silicon targets 24 and a rotary rack (not shown) positioned therein. The rotary rack is rotated as it holds the substrate 11(circular path 25), and the substrate 11 revolves on its own axis while it is moved along the circular path 25.

Magnetron sputtering of the outer layer 15 uses argon gas as sputtering gas. Argon gas has a flow rate of about 100 sccm to about 200 sccm. The temperature of magnetron sputtering is at about 100° C. to about 150° C., the power of the silicon target is in a range of about 2 kw to about 8 kw, a negative bias voltage of about −50 V to about −100 V is applied to the substrate and the duty cycle is about 30% to about 50%. The vacuum sputtering of the base layer takes about 90 min to about 180 min, the Si—N layer has a thickness at a range of about 0.5 μm-about 1 μm.

The antenna radiator 13 is sandwiched between the base 11 and the outer layer 15 so that the antenna radiator 13 is protected from being damaged. In addition, the antenna radiator 13 can be directly attached to the housing 10, thus, the working efficiency is increased.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A housing comprising:
a base;
an antenna radiator formed on the base, the antenna radiator made of conductive plastic;
an outer layer formed on the antenna radiator; the antenna radiator sandwiched between the base and the outer layer;
at least one conductive contact embedded in the base, one end of the at least one conductive contact electrically connected to the antenna radiator, and the other end of the at least one conductive contact exposed from the base.

2. The housing as claimed of claim 1, wherein the conductive plastic includes the thermoplastic 35% to 45% by weight, the organic filling substances 12% to 18% by weight, the non-conductive oxide 43% to 47% by weight.

3. The housing as claimed of claim 1, wherein the conductive small particle sized material is nanoparticles of silver, gold, copper, nickel, palladium, platinum, or alloy the conductive small particle sized material is carbon nanotube, the carbon nanotube, the particle diameter of the carbon nanotube is 20 nm˜40 nm, and the length of the carbon nanotube is 200 nm-5000 nm.

4. The housing as claimed of claim 1, wherein the outer layer is a non conductive Si—N layer.

5. A method for making a housing, comprising:
providing an injection molding machine defining a molding chamber;
placing at least one conductive contact into the molding chamber, and mixture material injected into the molding chamber to form a base, the at least one conductive contact directly embedded in the base;
injecting mixture of materials consisting of thermoplastic, organic filling substances, and conductive small particle sized material into the molding chamber to form an antenna radiator covering at least one part of the base;
forming an outer layer, the outer layer is a Si—N layer, forming Si—N layer by process of physical vapor deposition, the antenna radiator sandwiched between the outer layer and the base.

6. The method for making a housing as claimed of claim 5, wherein the conductive small particle sized material is nanoparticles of silver, gold, copper, nickel, palladium, platinum, or alloy the conductive small particle sized material is carbon nanotube, the carbon nanotube, the particle diameter of the carbon nanotube is 20 nm˜40 nm, and the length of the carbon nanotube is 200 nm-5000 nm.

7. The method for making a housing as claimed of claim 5, wherein the conductive small particle sized material is carbon nanotube, the carbon nanotube, the particle diameter of the carbon nanotube is 20˜40 nm, and the length of the carbon nanotube is 200-5000 nm.

8. The method for making a housing as claimed of claim 5, wherein magnetron sputtering the outer layer uses argon gas as sputtering gas, argon gas has flow rates of 100 sccm to 200 sccm, the temperature of magnetron sputtering is at 100° C. to 150° C., the power of the silicon target is in a range of about 2 kw to about 8 kw, a negative bias voltage of −50 V to −100 V is applied to the substrate and the duty cycle is 30% to 50%, vacuum sputtering the base layer takes 90 min to 180 min, the Si—N layer has a thickness at a range of about 0.5 μm-1 μm.
